(19) United States
(12) Patent Application Publication
(10) Pub. No.: US 2003/0119386 A1
(43) Pub. Date: Jun. 26, 2003

(54) Method and system for installing server-specific plug-ins

(76) Inventors: Thorsten O. Laux, Santa Clara, CA (US); Ingrid Halama, Hamburg (DE)

Correspondence Address: SONNENSCHEIN NATH & ROSENTHAL, P.O. BOX 061080, WACKER DRIVE STATION, CHICAGO, IL, 60606-1080, US

(21) Appl. No.: 10/300,907

(22) Filed: Nov. 21, 2002

(30) Foreign Application Priority Data
Nov. 21, 2001 (EP) 01 127 354.7

(51) Int. Cl. H01R 9/22

(52) U.S. Cl. 439/894

(57) ABSTRACT

Methods and systems consistent with the present invention provide efficiency and accuracy for use of plug-ins by installing server-specific plug-ins. Server-specific plug-ins are installed with unique identification, such as MIME types, referencing a specific server so that the plug-in may work in conjunction with that server. In this manner, similar plug-ins installed from different servers can automatically work specifically with its compatible server, thereby increasing flexibility, accuracy and ease of use while reducing ambiguity. As a result, a browser accessing a specific type of data, such as a MIME type, will automatically be directed to the correct server without significant reworking of the system. The decision where to route the activation request may be made in response to the MIME type of the plug-in that was installed. One advantage is the ability to use several versions of the same browser plug-in simultaneously on a client and to provide an automatic way to select the desired version and server.

### CROSS REFERENCE TO RELATED APPLICATION

This application is related to, and claims priority to, European Patent Application No. 01127354.7, filed on Nov. 21, 2001, commonly owned, and entitled “Processing Data Files Using Plug-Ins,” and which is hereby incorporated by reference herein in its entirety.

### BACKGROUND

1. Field of the Invention

The present invention generally relates to a method and system for installing plug-ins in a distributed environment. In particular, the present invention generally relates to browsers, plug-ins and the installation of server-specific plug-ins.

2. Background Information

Data processing devices are used for a wide range of versatile applications, providing services to potentially large numbers of different users. The applications may range from editing of text documents or spreadsheet applications to complex software systems, for example, for computer aided design and manufacturing, purchasing, computer aided banking applications, entertainment applications, and numerous other application areas. Increasingly complex software applications are employed in the field of personal services, for example, for personal data organization and mobile communication applications such as mobile telephones or communications services and other services provided over computer networks, such as the Internet.

In any of the above-outlined examples, particularly in a distributed environment involving processing of information at different physical locations, a number of different applications or modules of an application may interact and cooperate to provide a particular service. Further, different applications or modules of an application may be executed and interact on a single data processing device to provide a particular service.

In these cases, it is important that compatibility between different applications or, modules of applications, is provided. Further, it is important to provide different applications or modules of an application cooperating with one another with information on respective other applications or modules, in order to allow a correct addressing of calls or requests and to assure that the modules or applications communicate with the correct counterpart.

In many distributed systems, “browsers” are used to view and manipulate information. Commonly, a browser is a software application used to, for example, aid a user in locating, displaying and browsing through various types of data such as HyperText Markup Language (“HTML”) web pages. Many browsers can display text, graphics and multimedia information including sound and video, and many times a user using a browser may need to view, access or process a data file of a particular data type, such as a type of video file or audio file.

However, many browsers require “plug-ins” for accessing some types and formats of data. A plug-in is a hardware or software module that adds a specific feature or service to a larger system, and plug-ins typically allow browsers to access, process and display different types data, such as audio or video.

Various data files are typically classified in specific data file types. On large networks, such as the Internet, consistency in the data types, their names and formats helps many users interact with each other in a compatible manner. Designed by the Internet Engineering Task Force, one commonly used convention is Multipurpose Internet Mail Extensions (“MIME”) which is a specification for formatting non-ASCII messages so they can be sent over networks such as the Internet. MIME enables browsers to display and output files that are not in HTML format, and many browsers and e-mail applications support MIME which enables them to send and receive graphics, audio, and video files, for example, via the Internet mail system. MIME types typically identify a content type and allow a browser or server to select the correct type of viewer for the file. There are many predefined MIME types, such as GIF graphics files and PostScript files.

Generally, a browser uses one plug-in for a specific MIME type, meaning that any two files of the same MIME type that are requested to be processed are processed by the same plug-in. The browser may contain a registry of the correlation between plug-ins to MIME types. If a user wants to work with several versions of a browser plug-in simultaneously and all the versions are registered to the same MIME type, it depends on the browser implementation which plug-in version gets activated, but only one will be activated for that MIME type, typically the newest one.

This is a particular problem in distributed systems in which servers do most of the processing and the client functions are kept to a minimum. In such distributed environments, a client browser may request a server to process a data file of a given type, and a plug-in on the client streams the data file to the server for processing. Having no easy flexibility, the client always uses the same plug-in for that MIME type for processing. This is a problem in an environment where different server versions need different plug-in versions to work with. If a different version of the plug-in or different version of the processing application on the server is desired to process a data file of the same MIME type, the browser will automatically default to the one set for that specific MIME type, thereby having no flexibility. Additionally, there is the potential that if the client and server versions don't match, the application will not work.

For example, if a plug-in on a browser is installed and registered for a specific data type, such as StarOffice™ documents from Sun Microsystems, Inc., and a StarOffice document is activated in the browser, that plug-in is used to process it. The plug-in contacts the corresponding server and streams the document to the server for further processing.

If a new version of the product, i.e., the server and the plug-in, is implemented, the new plug-in will also be installed and registered for StarOffice documents, thereby creating an ambiguity because the previous version is also registered for that MIME type. In this case, there are two plug-ins and two servers both registered to process documents of the same MIME type. Conventional systems will select the same plug-in for that MIME type every time, thereby depriving the user of the flexibility of using different plug-ins, different servers and possibly different versions, for the same MIME type.

FIG. 1 depicts a block diagram representation of a related art system with a client 102 having a browser 104, a browser plug-in registry 106, three plug-ins 108 and three servers 110-114. As shown in the figure, a plug-in 108 of MIME type 1 is installed on three different versions of servers 110-114, and the client 102 requests installation of the plug-in from each server at different times. Each server 110-114 installs the plug-in 108 on the client 102 with the same MIME type, in this example, MIME type 1. During installation, each plug-in 108 is registered in the browser plug-in registry 106 as corresponding to MIME type 1.

As a result, when a user makes a service request for processing of data corresponding to MIME type 1 using a plug-in 108, there is an ambiguity because three different plug-ins on the client 102 correspond to that MIME type. Only one of the plug-ins 108 will be selected, typically the most recently installed plug-in, but that plug-in may not be the correct plug-in for use with a given server 110-114. This may pose a problem when another plug-in 108 exists that may be better for processing in conjunction with a given server 110-114. The user does not have the flexibility to conveniently automatically use another appropriate plug-in 108 for its corresponding server 110-114. It is therefore desirable to overcome these and related problems.

### SUMMARY OF THE INVENTION

Methods and systems consistent with the present invention provide efficiency and accuracy for use of plug-ins by installing server-specific plug-ins. Server-specific plug-ins are installed with unique identification, such as MIME types, referencing a specific server so that the plug-in may work in conjunction with that server. In this manner, similar plug-ins installed from different servers can automatically work specifically with its compatible server, thereby increasing flexibility, accuracy and ease of use while reducing ambiguity. As a result, a browser accessing a specific type of data, such as a MIME type, will automatically be directed to the correct server without significant reworking of the system. The decision where to route the activation request may be made in response to the MIME type of the plug-in that was installed. One advantage is the ability to use several versions of the same browser plug-in simultaneously on a client and to provide an automatic way to select the desired version and server.

Without server-specific plug-ins, the same plug-in may be installed on a client by more than one server having different versions, and all of the plug-ins will be installed on the client having the same MIME type. In this case, typically when a request is made to process a data file of a given MIME type, the browser will only use one of the installed plug-ins, commonly the most recently installed one. Since all of the plug-ins would have the same MIME type, the ambiguity means that the others are not used regardless of which server should be accessed.

In accordance with methods and systems consistent with the present invention, a method for installing server-specific plug-ins is provided. The method comprises the steps of installing a plug-in associated with a server, and assigning a unique identification to the plug-in, the identification uniquely associated with the server. The method also comprises using the unique identification to activate the plug-in.

In accordance with methods and systems consistent with the present invention, a method is provided in a data processing system for installing server-specific plug-ins. The method comprises generating a unique identification for a plug-in associated with a server, the identification uniquely associated with the server, and sending the unique identification and the plug-in to a client.

In accordance with methods and systems consistent with the present invention, a data processing system for installing server-specific plug-ins is provided. The data processing system comprises a memory having program instructions that install a plug-in associated with a server, assign a unique identification to the plug-in, the identification uniquely associated with the server, and use the unique identification to activate the plug-in. The data processing system also comprises a processor configured to execute the program.

In accordance with methods and systems consistent with the present invention, a data processing system for installing server-specific plug-ins is provided. The data processing system comprises a memory having program instructions that generate a unique identification for a plug-in associated with a server, the identification uniquely associated with the server, and send the unique identification and the plug-in to a client. The data processing system further comprises a processor configured to execute the program.

In accordance with methods and systems consistent with the present invention, a computer-readable medium containing instructions for controlling a data processing system for installing server-specific plug-ins to perform a method is provided. The method comprises the steps of installing a plug-in associated with a server, and assigning a unique identification to the plug-in, the identification uniquely associated with the server. The method further comprises using the unique identification to activate the plug-in.

In accordance with methods and systems consistent with the present invention, a computer-readable medium containing instructions for controlling a data processing system for installing server-specific plug-ins to perform a method is provided. The method comprises the steps of generating a unique identification for a plug-in associated with a server, the identification uniquely associated with the server, and sending the unique identification and the plug-in to a client.

In accordance with methods and systems consistent with the present invention, a data processing system for installing server-specific plug-ins is provided. The data processing system comprises means for installing a plug-in associated with a server, and means for assigning a unique identification to the plug-in, the identification uniquely associated with the server. The data processing system comprises means for using the unique identification to activate the plug-in.

### BRIEF DESCRIPTION OF THE DRAWINGS

The accompanying drawings, which are incorporated in and constitute a part of this specification, illustrate embodiments in accordance with the present invention and, together with the description, serve to explain the advantages and principles consistent with the present invention.

FIG. 1 depicts a block diagram representation of a related art system with a client having a browser, a browser plug-in registry, plug-ins and servers.

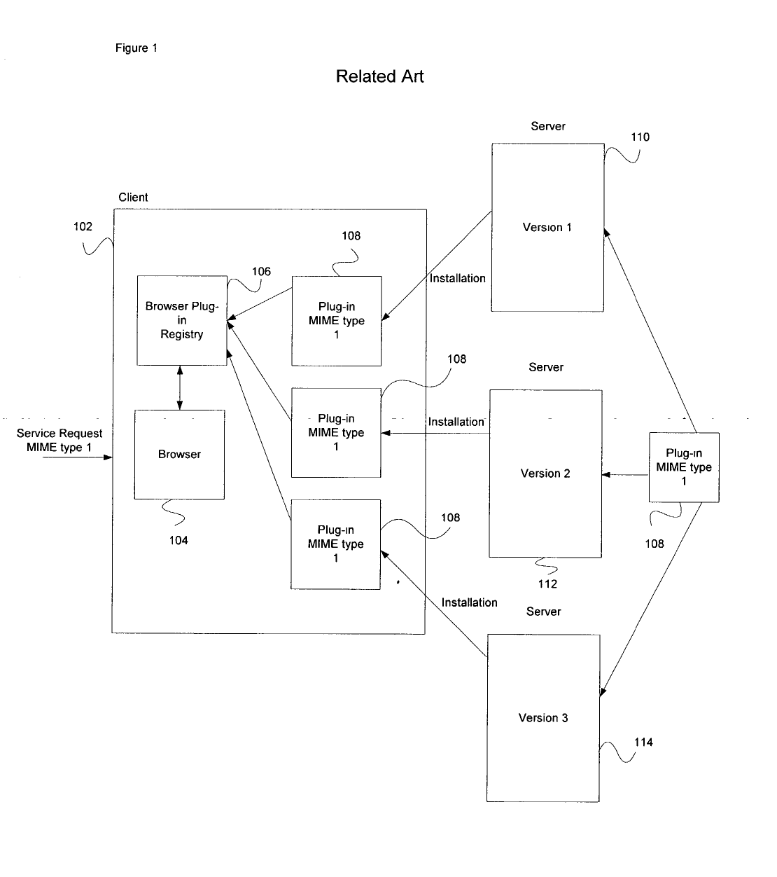

FIG. 2 depicts a block diagram of a data processing system suitable for practicing methods and systems consistent with the present invention.

FIG. 3 depicts a flowchart illustrating steps of a method relating to a server for installing server-specific plug-ins in a distributed system in accordance with methods and systems consistent with the present invention.

FIG. 4 depicts a system for installation of server-specific plug-ins after initiation of a client installation application in accordance with methods and systems consistent with the present invention.

FIG. 5 depicts a flowchart illustrating steps of a method relating to a client for installing server-specific plug-ins in a distributed system in accordance with methods and systems consistent with the present invention.

FIG. 6 depicts a system for the installation of server-specific plug-ins during execution of the client installation application and installation of the plug-in on the client in accordance with methods and systems consistent with the present invention.

FIG. 7 depicts a system during installation of a server-specific plug-in by a different server in accordance with methods and systems consistent with the present invention.

FIG. 8 depicts a system for activation of a server-specific plug-in in accordance with methods and systems consistent with the present invention.

### DETAILED DESCRIPTION

Methods and systems consistent with the present invention provide efficiency and accuracy for use of plug-ins by installing server-specific plug-ins. Server-specific plug-ins are installed with unique identification, such as MIME types, referencing not only a particular data type but also the particular data type suited for a specific server so that the plug-in may work in conjunction with that server. In this manner, similar plug-ins installed from different servers can automatically work specifically with its compatible server, thereby increasing flexibility, accuracy and ease of use while reducing ambiguity. As a result, a browser accessing a specific type of data, such as a MIME type, will automatically be directed to the correct server without significant reworking of the system. The decision where to route the activation request may be made in response to the MIME type of the plug-in that was installed. One advantage is the ability to use several versions of the same browser plug-in simultaneously on a client and to provide an automatic way to select the desired version and server.

Without server-specific plug-ins, the same plug-in may be installed on a client by more than one server having different versions, and all of the plug-ins will be installed on the client having the same MIME type. In this case, typically when a request is made to process a data file of a given MIME type, the browser will only use one of the installed plug-ins, commonly the most recently installed one. Since all of the plug-ins would have the same MIME type, the ambiguity means that the others are not used regardless of which server should be accessed. In systems without the installation functionality of the server, an efficient selection of different plug-ins for specific servers may not be possible. Instead, based on the data file type indicated in the service request, the same plug-in for performing the requested processing operations would always be selected regardless of which specific server should be used, in the absence of further selection information.

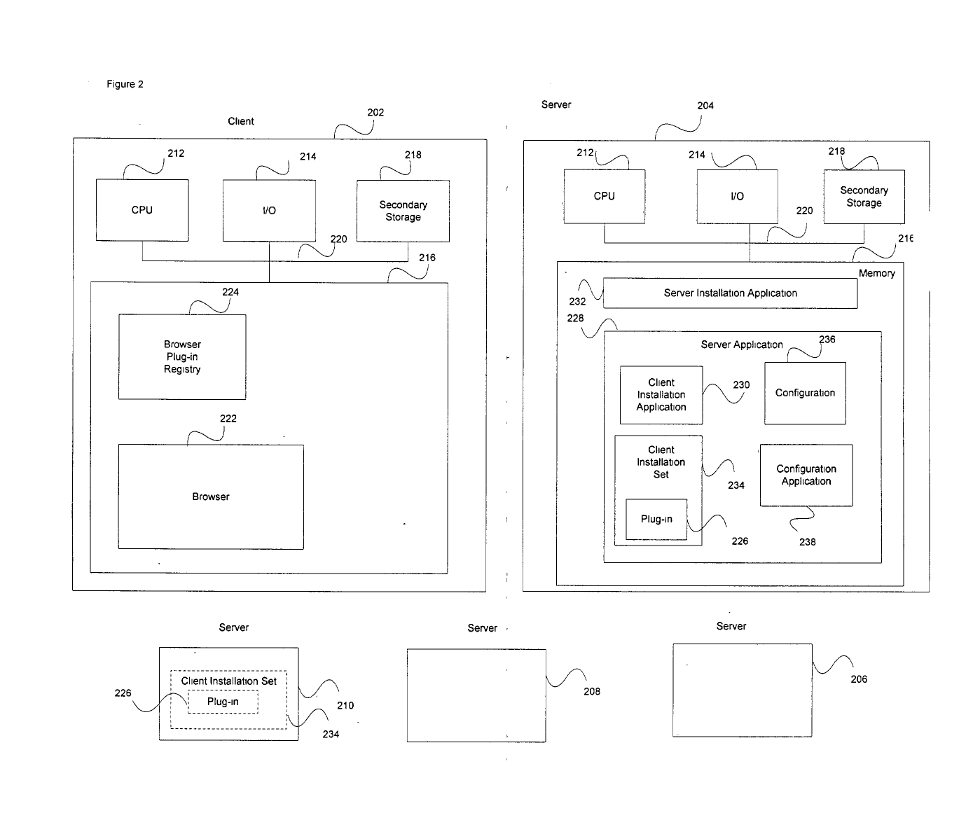

FIG. 2 depicts a block diagram of an exemplary data processing system suitable for practicing methods and implementing systems consistent with the present invention. FIG. 2 depicts a client computer 202 and server computers 204-210, and any of the computers may represent any kind of data processing device, such as a general purpose data processing device, a personal computer, a plurality of interconnected data processing devices, a mobile computing device, a personal data organizer, a mobile communication device including mobile telephones or other similar devices. The client 202 and servers 204-210 may represent computers in a distributed computing environment, such as Sun One Webtop developed by Sun Microsystems, Inc.

A client 202 includes a central processing unit 212 (“CPU”), and input-output (“I/O”) unit 214, a memory 216 such as a random access memory (“RAM”) or other dynamic storage device for storing information and instructions to be executed by the CPU. The client 202 also includes a secondary storage device 218, such as a magnetic disk or optical disk that may communicate with each other via a bus 220 or other communication mechanism.

Although aspects of methods, systems and articles of manufacture consistent with the present invention are described as being stored in memory, one having skill in the art will appreciate that all or part of methods and systems consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of the data processing system are described, one skilled in the art will appreciate that a data processing system suitable for use with methods, systems, and articles of manufacture consistent with the present invention may contain additional or different components.

The client 202 may further include input devices such as a keyboard, and mouse or speech processor (not shown) and a display device (not shown) such as a cathode ray tube (“CRT”), for displaying information to a user. The client 202 may include a human user or may include a user agent. The term “user” used herein refers to a human user, software, hardware or any other entity using the system.

As shown, the memory 216 in the client 202 includes a browser 222, and a browser plug-in registry 224. A browser application 222 is typically any program or group of application programs allowing convenient browsing through information or data available in distributed environments, such as the Internet or any other network including local area networks. A browser application 222 generally allows viewing, downloading of data and transmission of data between data processing devices. The browser 222 may also be other kinds of applications.

The browser plug-in registry 224 in the memory 216 stores information on plug-ins, plug-in names and plug-in MIME types. This registry 224 may be accessed by a browser 222 to determine which plug-in should be activated for a given MIME type. The browser plug-in registry 224 may be stored anywhere such as in the memory 216 or secondary storage 218. Further, the browser plug-in registry 224 could be stored at an external location, for example, such as on a data storage unit accessible by the browser 222 or client 202, and such a data storage unit could be accessible through a communication network.

A plug-in 226 may be a piece of software to be used in connection with a larger application program for providing a specific additional service, such as special text editing, graphical viewing, special spreadsheet applications, etc. A plug-in 226 may enhance a functionality of a browser application 222 for browsing through information available on a network of computing devices. Accordingly, a plug-in 226 may generally be a software module which may be added to any kind of larger software application, such as a browser application 222, to add a defined functionality. Further, a plug-in 226 may be added to the larger software application generally at any desired time, provided that the larger software application is equipped to receive and integrate the plug-in. The code for the plug-in 226 may be obtained from any source, such as over a computer network, a data storage medium or similar component. Alternatively, a plug-in 226 may also be a piece of hardware adding functionality to an application or larger hardware structure. Plug-ins 226 may also be designed to work best in conjunction with a specific server and may operate by communicating with that server.

Some examples of plug-ins 226 may include applications for displaying text information, such as Acrobat reader for displaying files in the PDF format, applications for displaying images in the GIF format, TIFF format, JPEG format, etc. Examples also include Moving Pictures Expert Group (“MPEG”) players for playback of videos in the MPEG format, wave-audio players for playback of digital sound files, e.g., WAV format, MP3 format. Further-examples are applications enabling user interaction for drawing and editing operations, JAVA applets, and software applications for remote visualization, such as the Remote Visualization Process protocol (“RVP”). Another example of plug-ins 226 are runtime environment component services to ensure convenient access from a first computer system to resources available at a second computer system. An example of a runtime environment component service is disclosed in the European patent application EP01100136.9, entitled “Runtime Environment Component Services” and filed Jan. 15, 2001, which is incorporated herein by reference.

In general, a plug-in 226 processes or handles a data file specified in the service request in a defined way. While the handling of the processing of the data file by different plug-ins 226 may be fundamentally different, it is also possible that different plug-ins carry out substantially the same functionality in certain variations. For example, it is possible that a group of plug-ins 226 constitute individual modifications of a basic plug-in, such as different release versions of the plug-in, or versions or instances of a plug-in associated with different versions or instances of operating applications involved in serving the service request.

Additionally, a plug-in 226 itself may not necessarily be a single unit, but may be realized in different sub-modules, which may even be arranged in a distributed environment. Thus, a plug-in 226 may supervise the processing of data by-placing calls to further sub-modules.

Although only one browser 222 and client 202 are shown on the FIG. 2, any number of browsers and clients may be used. Additionally, although shown on the client 202 in the memory 216, these components may reside elsewhere, such as in the secondary storage 218, or on another computer, such as another server 204. Furthermore, these components may be hardware or software whereas embodiments in accordance with the present invention are not limited to any specific combination of hardware and/or software.

FIG. 2 also depicts a server 204 that includes a CPU 212, an I/O unit 214, a memory 216 having a server application 228, and a secondary storage device 218 that communicate with each other via a bus 220. The server application 228 may also reside elsewhere, such a secondary storage 218. The server application 228 may be any application, e.g., a text processing application, a graphics application, a spreadsheet application, an application of a mobile computing device including a mobile telephone, a banking application, and entertainment application, or any other application. The server application 228 may be an application implementing StarOffice or related products such as Sun One Webtop. The server 204 may also have many of the components mentioned in conjunction with the client 202, and server 206-210 may also have any of the components shown on server 204.

The client 202 and servers 204-210 may communicate directly or over networks, and may communicate via wired and/or wireless connections or any other method of communication. Communication may be done through any communication protocol, including known and yet to be developed communication protocols. The network may comprise many more clients 202 and servers 204-210 than those shown on the figure, and the client and server may also have additional or different components than those shown.

The memory 216 of the servers 204-210 may also include additional components such as a configuration 236, configuration application 238, server installation application 232, client installation application 230, client installation set 234 and plug-in 226, which will be discussed in further detail below.

FIG. 2 also depicts a system for installation of server-specific plug-ins in accordance with methods and systems consistent with the present invention. As an overview, in one embodiment, when a server 204 receives a request to install a plug-in 226, a client installation application 230 executes and is sent to the client 202 and facilitates the installation of the requested plug-in which is given a unique MIME type specific to the server with which it operates.

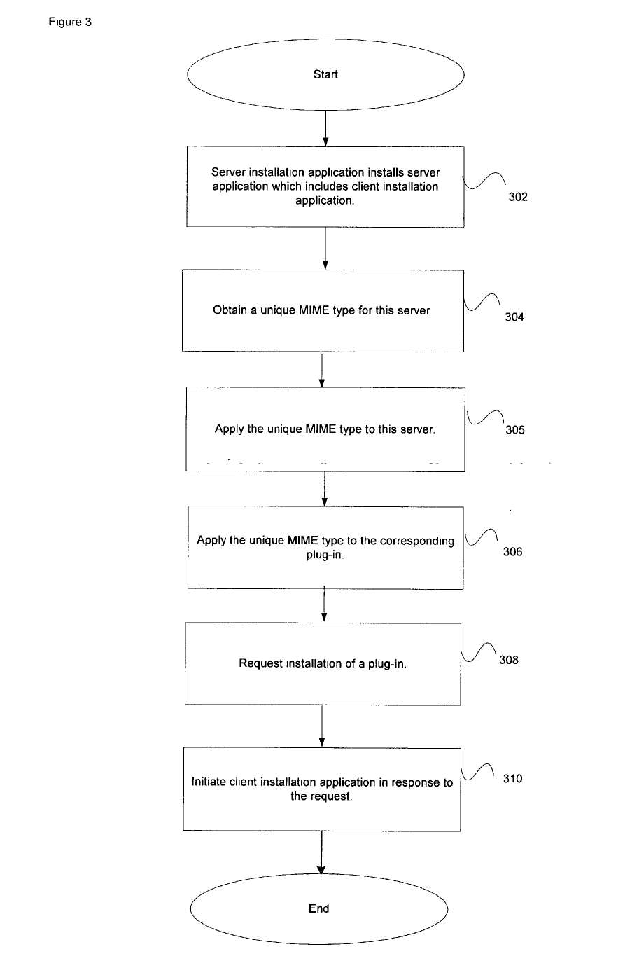

FIG. 3 is a flowchart illustrating steps of an exemplary method for installing server-specific plug-ins in a distributed system in accordance with the present invention, and will be discussed in conjunction with FIG. 2. First, an administrator installs the server application 228, e.g., Sun One Webtop, on a server machine 204 with help of a server installation application 232. The server installation application 232 installs the server application 228 which includes a client installation application 230 and a client installation set 234 (step 302). The client installation application 230 may also include additional components. The client installation application 230 will be used in conjunction with the client 202 to install the plug-in 226 on the client with a MIME type specific to the server 204 or server application 228.

The client installation set 234 includes a set of files which includes a plug-in 226, and may also include additional components such as libraries, resource files, bitmaps, readme and license text files, executable files, fonts and configuration files. In one embodiment consistent with the present invention, this plug-in 226 may have a non-unique MIME type and name while provided in the client installation set 234, for example, because this same server application 228 may be installed on other servers 206-210, and the plug-in may be the same during those installations. In another embodiment, a unique MIME type and name could be assigned to the plug-in 226 in the client installation set 234 during or before installation of the server application 228.

The server application 228 may also include a configuration 236 and a configuration application 238, which can be used by an administrator to modify the configuration of the server application. This may be useful because, in one embodiment, the client installation set 234 may be provided on a separate File Transfer Protocol (“FTP”) server 210 as indicated by the dashed lines. The location of the client installation set 234 on this FTP server 210 may be stored in the configuration 236, possibly entered by the administrator via the configuration application 238 or by editing the configuration 236, thus being accessible for use by the client installation application 230.

A unique MIME type is obtained for this server (step 304). There may be different ways and times to obtain a unique MIME type corresponding to this server application 228 and its corresponding plug-in 226. A unique MIME type may be generated automatically by the server installation application 232 during installation of the server application 228. In an alternative embodiment, the unique MIME type could be generated during production of the server installation package and added as a unique paste-on label to the package, e.g., the Sun One Webtop installation package. Another option may be to have a central online service where the package can be registered for obtaining a unique MIME type. In another embodiment, the unique MIME type may be generated by the server application 228 on demand when the first request to install the plug-in 226 is received. It may be desirable to also obtain a unique name for the plug-in 226, for example to allow installation of more than one plug-in in the plug-in registry 224 of a browser 204. Obtaining the unique name than could be handled in the same manner as obtaining the unique MIME type. Although these examples are given, any other method or system may be used.

The unique MIME type (and possibly a unique name) is applied to the server application 228 for further processing (step 305). To achieve this, the obtained unique MIME type (and possibly a unique name) is stored in the configuration 236. There may be different ways and times to store the unique MIME type (and possibly a unique name) to the configuration 236. The unique MIME may by stored by the server installation-application 232 during installation of the server application 228 into the configuration 236.

In an alternative embodiment, an administrator may manually enter the unique MIME type to the configuration 236 after the server application 228 is installed. This may happen by editing the configuration 236 using the configuration application 230 or by editing the configuration 236 directly if it comprises simple files. In another embodiment, the unique MIME type may be stored to the configuration 236 by the server application 228 itself if the MIME type was generated automatically on demand. Although these examples are given, any other method or system may be used.

The unique MIME type is applied to the corresponding plug-in (step 306), and there may be different ways and times to apply the unique MIME type (and possibly a unique name) to the plug-in 226. In one embodiment, the server installation application 232 applies the unique MIME type during installation of the server application 228 to the plug-in 226. For this, a reserved part of the plug-in binary could be overwritten with the unique MIME type. In an alternative embodiment, the unique MIME type may be applied to the plug-in 226 during the client installation process which is described below. Although these examples are given, any other method or system may be used.

To request installation of a plug-in 226, in one embodiment, the user first contacts the server application 228 via a browser 222 on the client 202 (step 308). The server application 228 generates different HTML pages as the user clicks on different-links or buttons, e.g., a login screen, a welcome screen, etc., and these HTML pages are displayed on the browser 222 on the client 202. The user may, for example, click on a special link in one of these pages to start the installation of a desired plug-in 226, which will in turn start the execution of the client installation application 230 on the corresponding server application 228 (step 310). However, the client installation application 230 may also start automatically as a reaction to a user interaction with one of the server-generated pages. For example, the user may click on a link to show a document but does not have an installed plug-in 226 for viewing the document. In this case, the request to trigger the client installation application 230 is sent by the browser 222 as a reaction to a user action but the Universal Resource Locator (“URL”) that was used is generated by the server application 228. The installation request could also be issued by any application providing a certain service or functionality, located either within the client 202, or could be located externally, in which case the installation request could be received over a communication link.

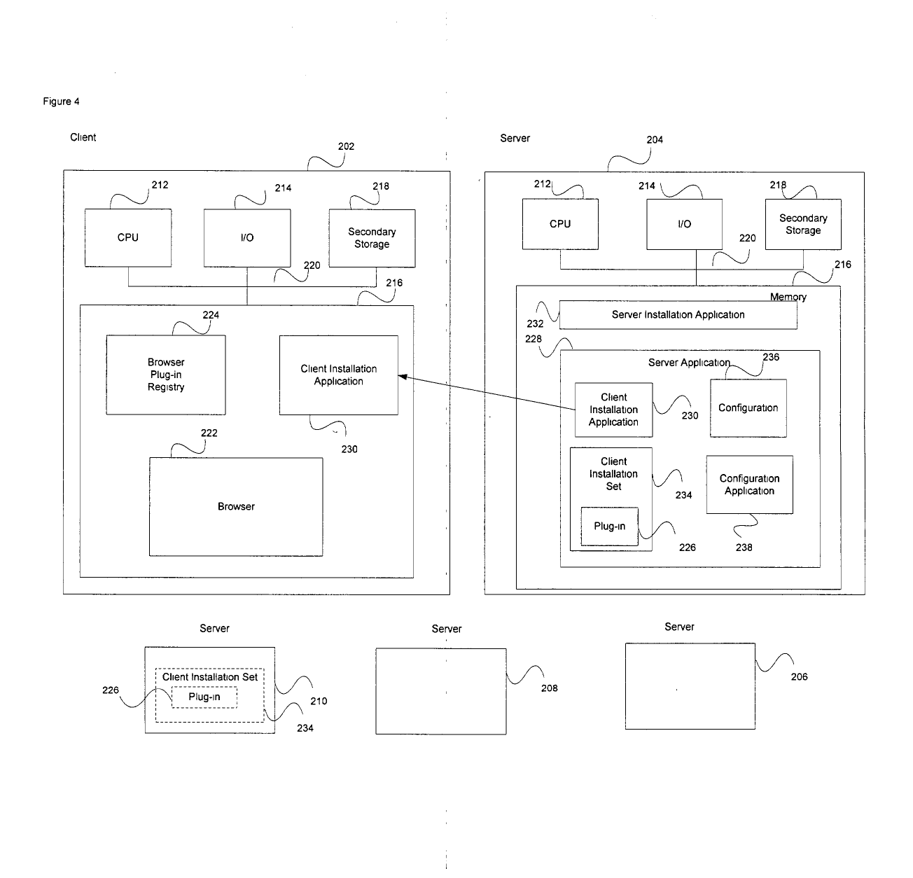

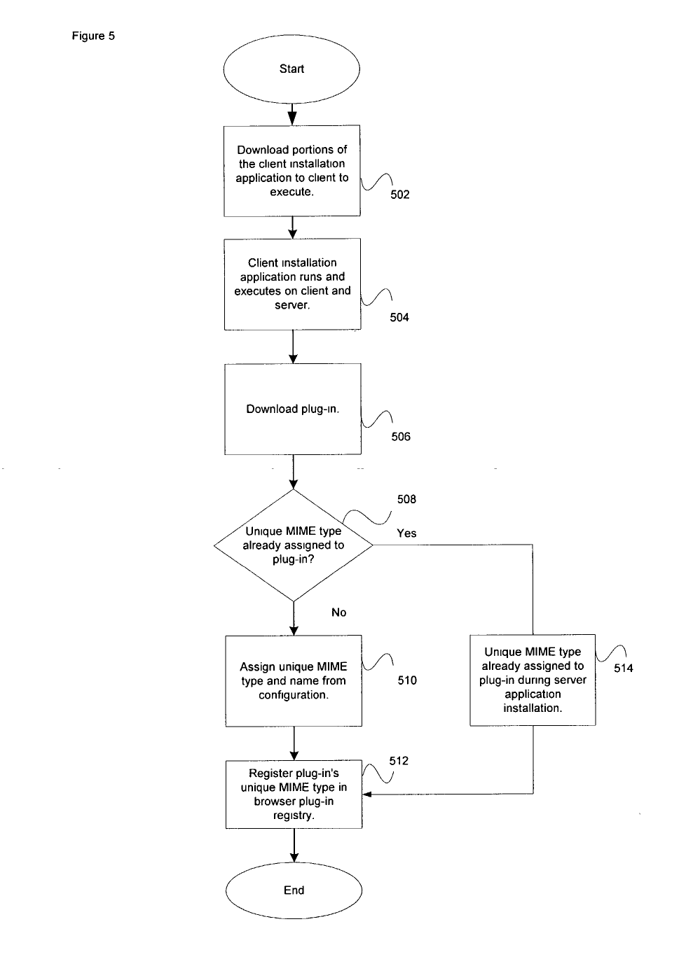

FIG. 4 depicts a system for installation of server-specific plug-ins after initiation of a client installation application 230 in accordance with methods and systems consistent with the present invention, and is also discussed in conjunction with FIG. 5 which is a flowchart illustrating steps of a method relating to a client for installing server-specific plug-ins in a distributed system in accordance with the present invention. As shown on FIG. 4, when the client installation application 230 is first executed, portions of the client installation application are downloaded to the client 202 to be executed on the client (step 502). In one embodiment, the client installation application 230 then runs and executes on both the client 202 and server 204 (step 504). In one embodiment, the client installation application 230 comprises at least three parts. These include (1) a server component that provides information from the server's configuration 236 and generates HTML pages with embedded applets, a client component that itself comprises two parts, (2) applets and (3) a native executable which is downloaded and started by the applets. The applet starts and uses the native executable to help it with its task to perform the full installation of the plug-in 226 and any other desired components. The client installation process may request the user to give input to prepare for installation, such as the preferred installation location, available disk space, type of operating system, and types of installed browsers and their locations. The server component of the client installation application 230 provides the client component with necessary information, i.e., the unique MIME type, possibly the unique name and the location from where to download the files of the client installation set 234 including the plug-in 226. This information may be stored previously in the server's configuration 236.

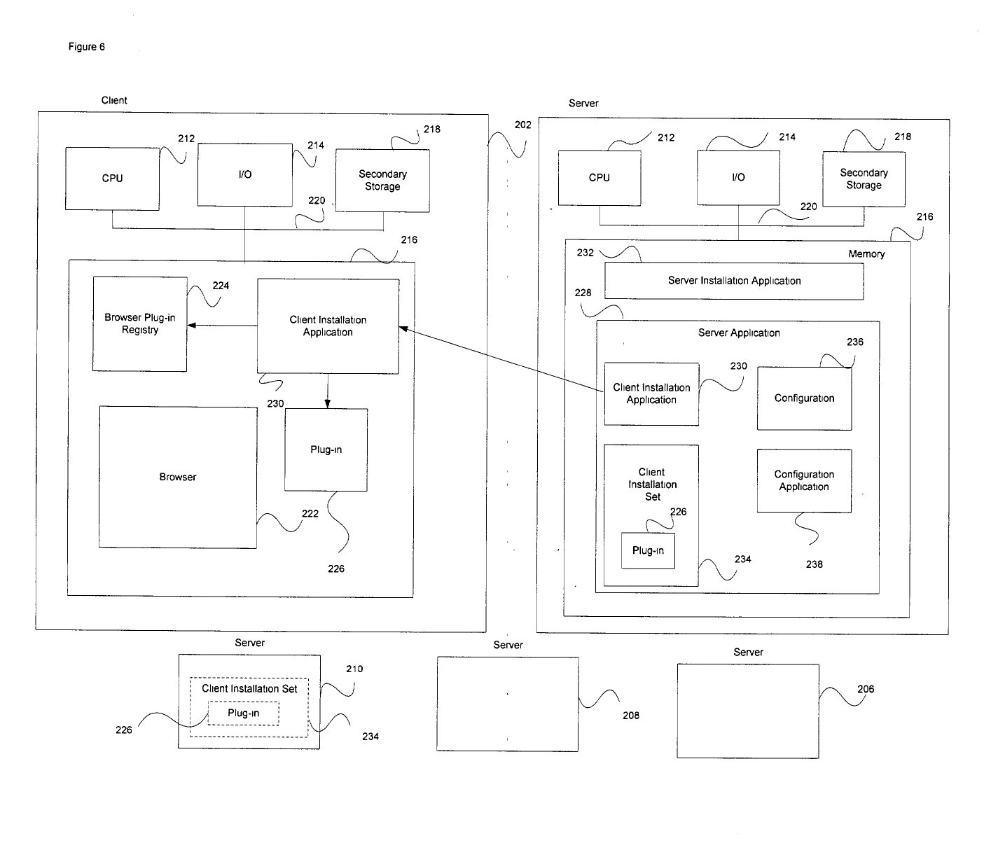

FIG. 6 depicts a system for the installation of server-specific plug-ins during execution of the client installation application 230 and installation of the plug-in 226 on the client in accordance with methods and systems consistent with the present invention, and this figure is also discussed in conjunction with FIG. 5. As shown on the figure, the client installation application 230 retrieves the plug-in 226 and installs it on the client 202 (step 506).

In one embodiment, the plug-in 226 still has a non-unique MIME type and non-unique name during download to the client 202. If a unique MIME type was not already assigned to the plug-in 226 in the client installation set 234 (step 508), the client installation application 230 assigns the unique MIME type to the downloaded plug-in 226, renames it to the unique name (step 510), and registers it with this unique MIME type to the browser plug-in registry 224 on the browser 222 (step 512). In one embodiment, the client installation application 230 overwrites a reserved part of the plug-in binary with the unique MIME type and afterwards calls a method of the plug-in 226 to register itself in the browser plug-in registry 224. After registry with the browser plug-in registry 224, the plug-in 226 will have a unique MIME type specific to the server application 228.

As mentioned previously, in another embodiment consistent with the present invention, the unique MIME type and name may have already been assigned to the plug-in 226 in the client installation set 234 before downloading to the client (step 514). In this case, the client installation application 230 will only need to know the location from where to download the plug-in 226. It will not need to rename the file nor.to do any binary patching to assign a different MIME type.

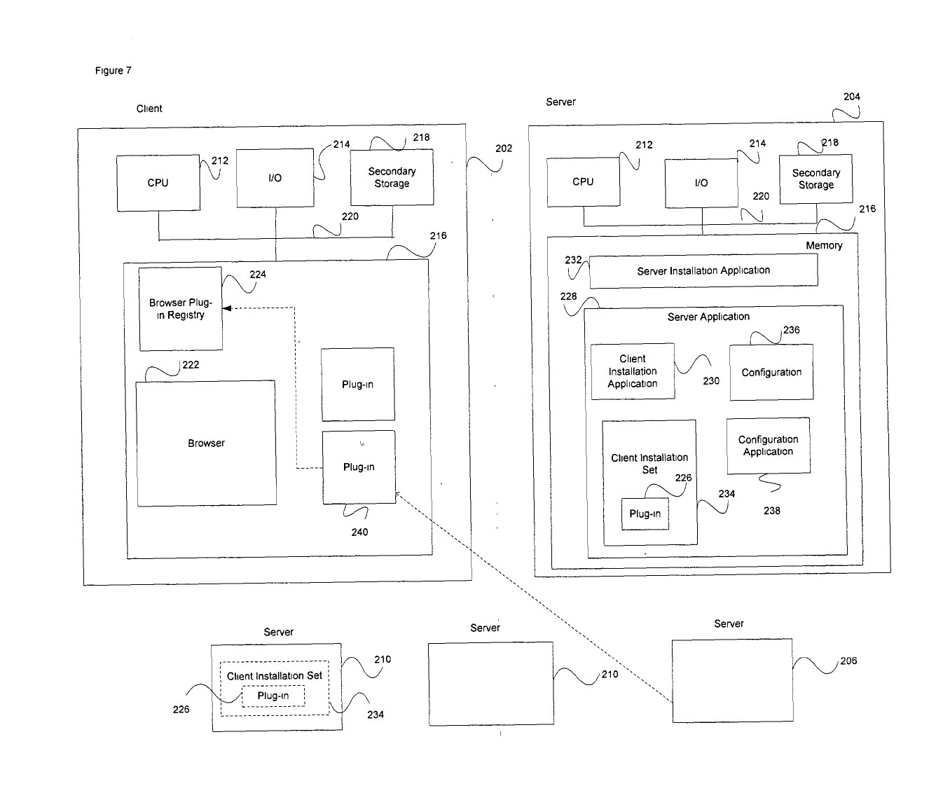

FIG. 7 depicts the installation of a server-specific plug-in by a different server in accordance with methods and systems consistent with the present invention. In this figure, the server 206 causes the installation of the plug-in 226 on the client 202 and registry of the plug-in in the browser plug-in registry 224 in the same manner as the server 204 did in FIGS. 4 and 6. Although the process is the same as in FIGS. 4 and 6, dashed lines are shown for simplicity on the figure instead of illustration of the full process displayed in FIGS. 4 and 6. It can be seen from this figure that the client 202 will then have two plug-ins 226 and 240, but the browser plug-in registry 224 will have different MIME types for each one of the plug-ins, each MIME type corresponding to the appropriate server 204 or 206 for that plug-in.

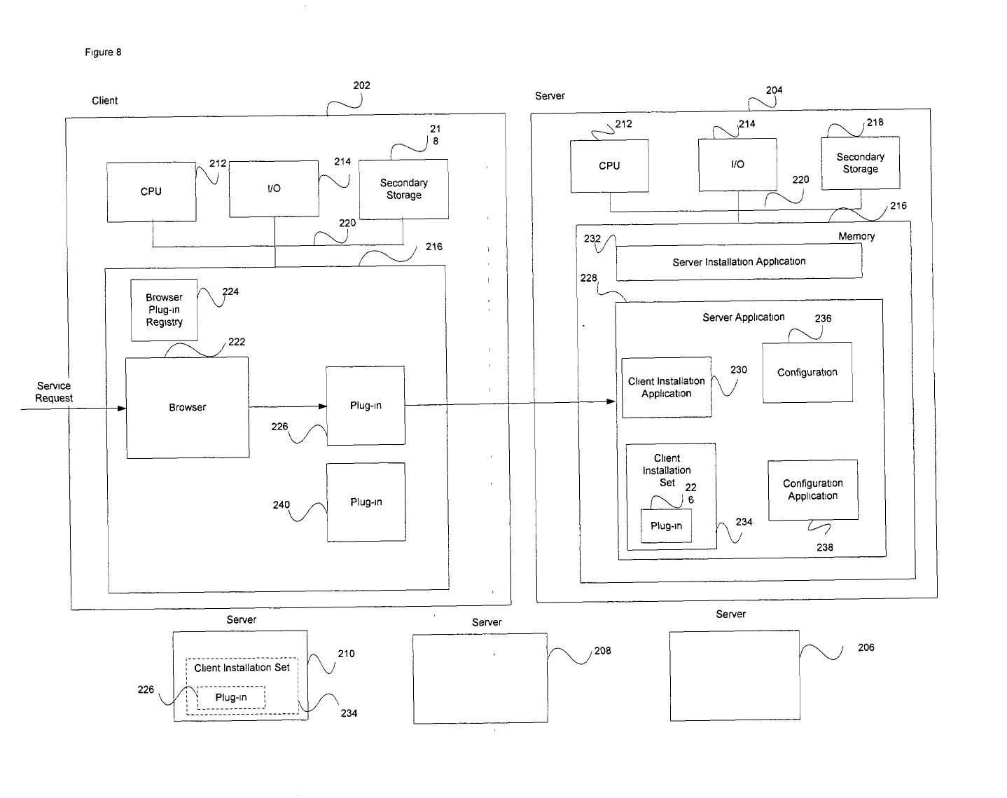

FIG. 8 depicts a system for the activation of a server-specific plug-in in accordance with methods and systems consistent with the present invention. Once the server-specific plug-in is installed on the client 202, in one embodiment, it will only be activated in combination with the specific originating server application 228 whereas no other server uses this MIME type. To activate the installed plug-in 226, the user may browse to the server application 228 with its browser 222. After log in, for example, the user may browse through the HTML pages offered by the server application 228 and click on a link representing a document, e.g., StarOffice document, stored on the server application. The document may be any data file, such as a text document, video file, audio file, multimedia file, etc. The document may have any other format or type, may include instructions for triggering execution of a certain functionality, and may include parameters to be processed or have other aspects.

In response to this request, the server application 228 generates an HTML page which includes a section having the unique server-specific MIME type which causes the browser 222 to access its browser plug-in registry 224 for that MIME type and activate the corresponding registered plug-in 226. In one embodiment, the plug-in 226 then communicates with the server application 228 to open the document and enable the user to view and edit.

Sometimes a client 202 may need to modify its plug-ins 228. If the client 202 is installed with a server-specific plug-in 228, in one embodiment, it will not be modified by any other server than its own specific server. One example for modifying a client's existing plug-ins 228 may occur when the user browses to the server application 228 with its browser 222, and after log in, the user browses through the HTML pages offered by the server application 228 and clicks on a link to start the client installation application. In this case, the client installation application 230 may start and enable the user to remove the plug-in 226, change submodules of the plug-in, or update to a newer version of the plug-in. The client installation application 230 identifies the plug-in 226 it is allowed to modify via the unique server-specific MIME type.

Another example shows that the client installation application 230 may start automatically again even if the plug-in 226 is already installed for that server application 228. In this case, a server application 228 may be installed in a version 1, and a user has obtained the plug-in 226 associated with version 1 of the server. During a downtime, the server application 228 is-upgraded to a new version 2, and the updated server application 228 may still be configured with the same unique MIME type as before in the older version 1. If the user connects now to the updated server application 228, the version 1 of the plug-in 226 that is associated with this server application 228 may be detected automatically, and the client installation application 230 may start automatically to update the plug-in 226 to the new version.

Other embodiments of the invention will be apparent to those skilled in the art from consideration of the specification and practice of the invention disclosed herein. Furthermore, embodiments of the present invention may be implemented by computer programs that may be stored on computer-readable media. It is intended that the specification and examples be considered as exemplary, with a true scope and spirit of the invention being indicated by the following claims.

What is claimed is:

1. A method in a data processing system for installing server-specific plug-ins, comprising the steps of:
installing a plug-in associated with a server;
assigning a unique identification to the plug-in, the identification uniquely associated with the server; and
using the unique identification to activate the plug-in.

2. The method of claim 1, wherein the unique identification is a MIME type.

3. The method of claim 1, wherein the method further comprises the steps of:
activating the plug-in; and
communicating between the plug-in and the associated server in response to the activation of the plug-in.

4. The method of claim 1, wherein the method further comprises the step of:
sending a request for installation of the plug-in.

5. The method of claim 1, wherein the method further comprises the step of:
generating the unique identification.

6. The method of claim 5, wherein the method further comprises the step of:
storing the unique identification in a configuration.

7. The method of claim 1, wherein the method further comprises the step of:
registering the plug-in and the unique identification in a browser plug-in registry.

8. A method in a data processing system for installing server-specific plug-ins, comprising the steps of:
generating a unique identification for a plug-in associated with a server, the identification uniquely associated with the server; and
sending the unique identification and the plug-in to a client.

9. The method of claim 8, wherein the identification is a MIME type.

10. The method of claim 8, wherein the method further comprises the steps of:
activating the plug-in; and
communicating between the plug-in and the associated server in response to the activation of the plug-in.

11. The method of claim 8, wherein the method further comprises the step of:
sending a request for installation of the plug-in.

12. The method of claim 8, wherein the method further comprises the step of:
registering the plug-in and unique identification in a browser plug-in registry.

13. A data processing system for installing server-specific plug-ins, comprising:
a memory having program instructions that install a plug-in associated with a server, assign a unique identification to the plug-in, the identification uniquely associated with the server, and use the unique identification to activate the plug-in; and
a processor configured to execute the program.

14. A data processing system for installing server-specific plug-ins, comprising:
a memory having program instructions that generate a unique identification for a plug-in associated with a server, the identification uniquely associated with the server, and send the unique identification and the plug-in to a client; and
a processor configured to execute the program.

15. A computer-readable medium containing instructions for controlling a data processing system for installing server-specific plug-ins to perform a method comprising the steps of:
installing a plug-in associated with a server;
assigning a unique identification to the plug-in, the identification uniquely associated with the server; and
using the unique identification to activate the plug-in.

16. The computer-readable medium of claim 15, wherein the unique identification is a MIME type.

17. The computer-readable medium of claim 15, wherein the method further comprises the steps of:
activating the plug-in; and
communicating between the plug-in and the associated server in response to the activation of the plug-in.

18. The computer-readable medium of claim 15, wherein the method further comprises the step of:
sending a request for installation of the plug-in.

19. The computer-readable medium of claim 15, wherein the method further comprises the step of:
generating the unique identification.

20. The computer-readable medium of claim 19, wherein the method further comprises the step of:
storing the unique identification in a configuration.

21. The computer-readable medium of claim 15, wherein the method further comprises the step of:
registering the plug-in and the unique identification in a browser plug-in registry.

22. A computer-readable medium containing instructions for controlling a data processing for installing server-specific plug-ins, to perform a method comprising the steps of:
generating a unique identification for a plug-in associated with a server, the identification uniquely associated with the server; and
sending the unique identification and the plug-in to a client.

23. The computer-readable medium of claim 22, wherein the identification is a MIME type.

24. The computer-readable medium of claim 22, wherein the method further comprises the steps of:
activating the plug-in; and
communicating between the plug-in and the associated server in response to the activation of the plug-in.

25. The computer-readable medium of claim 22, wherein the method further comprises the step of:
sending a request for installation of the plug-in.

26. The computer-readable medium of claim 22, wherein the method further comprises the step of:
registering the plug-in and unique identification in a browser plug-in registry.

27. A data processing for installing server-specific plug-ins, comprising the steps of:
means for installing a plug-in associated with a server;
means for assigning a unique identification to the plug-in, the identification uniquely associated with the server; and
means for using the unique identification to activate the plug-in.
